(19) United States
(12) Patent Application Publication
(10) Pub. No.: US 2025/0181224 A1
(43) Pub. Date: Jun. 5, 2025

(54) IMPLEMENTING DIALOG-BASED IMAGE EDITING

(71) Applicant: Lemon Inc., Grand Cayman (KY)

(72) Inventors: Celong LIU, Los Angeles, CA (US); Minhao LI, Los Angeles, CA (US); Qingyu CHEN, Los Angeles, CA (US); Xing MEI, Los Angeles, CA (US)

(21) Appl. No.: 18/527,016

(22) Filed: Dec. 1, 2023

(51) Int. Cl. G06F 3/04845; G06F 40/40; G06T 11/60

(52) U.S. Cl. CPC G06F 3/04845; G06F 40/40; G06T 11/60

(57) ABSTRACT

The present disclosure describes techniques for implementing dialog-based image editing. Text indicating a task of editing an image is received. A list of objects and attributes associated with each of the objects is generated based on the text and the image. The objects are comprised in the image. Operations to be performed on each of the objects are determined. An order of performing the operations on an object-by-object basis are determined. A plan of implementing the task is generated based on the text and the order of performing the operations. The plan comprises information indicating a set of algorithm tools selected for the task. Executable code is generated based at least in part on the plan. The code is executed to generate an edited image.

### BACKGROUND

Techniques for image editing are widely used in a variety of industries, including social media, graphic design, photography, advertising, media production, etc. Recently, the demand for image editing is getting even stronger. However, conventional image editing techniques may not fulfill the needs of users due to various limitations. Therefore, improvements in image editing techniques are needed.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for implementing dialog-based image editing.

FIG. 2 shows an example user interface for implementing dialog-based image editing.

FIG. 3 shows an example user interface for implementing dialog-based image editing.

FIG. 4 an example user interface for implementing dialog-based image editing.

FIG. 5 shows an example process for implementing dialog-based image editing.

FIG. 6 shows an example process for implementing dialog-based image editing.

FIG. 7 shows an example process for implementing dialog-based image editing.

FIG. 8 shows an example process for implementing dialog-based image editing.

FIG. 9 shows an example process for implementing dialog-based image editing.

FIG. 10 shows an example process for implementing dialog-based image editing.

FIG. 11 shows an example process for implementing dialog-based image editing.

FIG. 12 shows an example process for implementing dialog-based image editing.

FIG. 13 shows an example computing device which may be used to perform any of the techniques disclosed herein.

### DETAILED DESCRIPTION OF ILLUSTRATIVE EMBODIMENTS

Users may want to edit images, such as images that they have captured. It is convenient for users (especially users that are inexperienced in image editing) to be able to edit images using natural language input. To edit an image using natural language input, a user may type or speak in sentence form. The sentences may indicate one or more modifications (e.g., editing tasks) that the user wants to apply to an image. One such technique that enables users to edit images using natural language is stable diffusion (i.e., an emerging computer vision neural network). A user can provide an image, an editing task described in natural language, and/or an area in the image where the user wants to modify the image (e.g., the user may circle the area with a brush) to the neural network. The neural network may generate a modified image based on the image, the editing task described in natural language, and/or the area in the image where the user wants to modify the image.

However, there are several drawbacks to using stable diffusion for performing natural language image editing tasks. First, the output results are very unstable. Stable diffusion is often only able to add an object to an image. Further, the output results are often distorted. For example, modifying the expression of a person in an image may result in a distorted face, or adding a cat to an image may result in a five-legged cat. Second stable diffusion has a weak editing ability. It may be unable to perform refined operations, and/or may be unable to modify an image repeatedly. For example, a user may have multiple image editing demands, and stable diffusion may only achieve one-to-one input and output (e.g., the user cannot finetune the image based on the last editing result). As another example, stable diffusion may not allow users to perform operations such as undo. As such, improved techniques for implementing dialog-based image editing are needed.

Described herein are improved techniques for implementing dialog-based image editing. The dialog-based image editing techniques described herein enable fine-grained, controllable, and flexible image editing through natural language. The dialog-based image editing techniques described herein solve the difficulties faced by existing natural language image editing systems. For example, the dialog-based image editing techniques described herein overcome the input word limit of large language models. The optimized framework ensures the accuracy of algorithm scheduling. Further, the dialog-based image editing techniques described herein support algorithm scheduling with logical operations, reduce the cost of using large language models, and realize the solidification of algorithm scheduling.

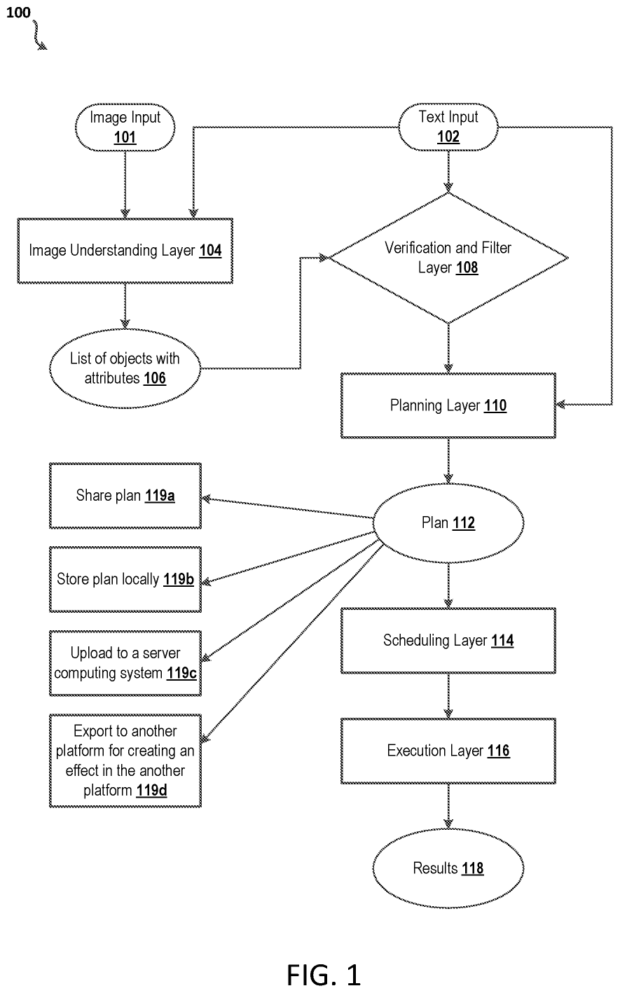

FIG. 1 shows an example system 100 for implementing dialog-based image editing. The system 100 may receive, as input, an input image 101 and input text 102. The input image 101 may comprise an image that a user wants to edit or modify. The user may upload the image 101 to the system 100. The input text 102 may comprise natural language, such as natural language that describes an image editing task that the user wants the system 100 to perform on the input image 101. The system 100 may comprise an image understanding layer 104, a verification and filter layer 108, a planning layer 110, a scheduling layer 114, and an execution layer 116. The system 100 may edit the input image 101 based on the input text 102.

In embodiments, the image understanding layer 104 may receive the input image 101 and the input text 102. The image understanding layer 104 may be configured to convert (e.g., change) the input image 101 into text. The text may be consumable by a large language model (LLM). However, unlike existing techniques that use a small quantity of general algorithms to convert an input image into a brief text description (e.g., one or two sentences describing the image), the image understanding layer 104 may convert the input image 101 into a list of objects with their respective attributes 106. The list of objects 106 may comprise a list of objects depicted in the input image 101, such as people, animals, inanimate objects, etc. For example, the list of objects and attributes 106 may indicate how many objects are in the image 101, and a type and position associated with each image. The list of objects with their respective attributes 106 may comprise attributes corresponding to each object. If an object is a person, the corresponding attributes may indicate gender, facial expression, hair color, etc. If an object is a cat, the corresponding attributes may indicate color, size, etc. The list of objects with attributes 106 contain a greater amount of information about the input image 101 and are much more accurate than the brief text description that is generated by existing techniques. As such, the system 100 may edit images more accurately than existing techniques.

The image understanding layer 104 may generate the list of objects and attributes 106 using one or more visual algorithms. The image understanding layer 104 may select the one or more visual algorithms (e.g., computer vision detection and tracking algorithms) from a plurality of visual algorithms. Each of the plurality of visual algorithms may be used to perform a specific task. For example, one of the plurality of visual algorithms may be configured to perform a face detection task. As another example, one of the plurality of visual algorithms may be configured to perform human body detection. As another example, one of the plurality of visual algorithms may be an image style algorithm. The image understanding layer 104 may select the one or more visual algorithms from a plurality of visual algorithms based on the input image 101 and/or the input text 102. For example, the image understanding layer 104 may utilize one or more large language models (LLM) to analyze the image editing task indicated by the input text 102 and determine which visual algorithm(s) from the plurality of visual algorithms should be used to generate the list of objects and their respective attributes for performing the image editing task. The image understanding layer 104 may generate the list of objects and attributes 106 using the selected visual algorithm(s).

In embodiments, the verification and filter layer 108 determines one or more algorithm tools (e.g., operations) from a plurality of algorithm pools to be performed on each of the objects in the list of objects generated by the image understanding layer 104. The verification and filter layer 108 may receive, as input, the list of objects and their respective attributes 106 and the input text 102. To determine the algorithm tools to be performed on each of the objects in the list of objects 106, the verification and filter layer 108 may determine, for each object in the list of objects, whether one or more image editing operations need to be performed on the object. The verification and filter layer 108 may determine, for each object in the list of objects, whether one or more image editing operations need to be performed on the object based on the input text 102. For example, if the input text 102 indicates that the user wants to change the facial expression of a man (but not a woman) in the input image 101, the verification and filter layer 108 may determine that one or more algorithm tools need to be performed on the man and that no algorithm tools need to be performed on the woman. For example, the verification and filter layer 108 may utilize one or more LLMs to analyze the image editing task indicated by the input text 102 to determine whether one or more image algorithm tools need to be used on each object.

If the verification and filter layer 108 determines that one or more algorithm tools need to be performed on a particular object in the list of objects generated by the image understanding layer 104, the verification and filter layer 108 may determine which specific algorithm tools need to be applied on that object. For example, the verification and filter layer 108 may utilize one or more LLMs to analyze the image editing task indicated by the input text 102 to determine which algorithm tool(s), if any, need to be performed on each object. The algorithm tools to be performed on a particular object in the list of objects 106 may herein be referred to as an “object plan” for the object. The object plans may be sent to the planning layer 110.

In embodiments, descriptions (e.g., partial information about each algorithm tool) corresponding to the plurality of algorithm tools may be generated. The descriptions may be generated based on the algorithm tool specifications (e.g., complete information about each algorithm tool). The descriptions may be input into the LLM(s) utilized by the verification and filter layer 108. The LLM(s) may utilize the descriptions associated with the each of the plurality of algorithm tools, along with the input text 102, to determine which algorithm tools need to be performed on each object in the list of objects 106.

In embodiments, the verification and filter layer 108 may process the descriptions (e.g., partial information about each algorithm tool) corresponding to the plurality of algorithm tools in batches (e.g., groups) to determine which algorithm tools(s) need to be performed on each object in the list of objects 106. If the total size of the descriptions is greater than an input limit of the LLM(s) and/or the quantity of algorithm tools exceeds (e.g., is greater than) a threshold (e.g., 100, 200, 250, etc.), the algorithm tools may be divided into a plurality of batches. The descriptions corresponding to each of the plurality of batches may be sequentially input into the LLM(s). For example, descriptions corresponding to the algorithm tools in a first batch of the plurality of batches may be input into the LLM(s), then descriptions corresponding to the algorithm tools in a second batch of the plurality of batches may be input into the LLM(s), and so on. Based on the input descriptions, the verification and filter layer 108 may determine any quantity (zero, one, or more than one) of algorithm tools from each batch that need to be performed on an object in the list of objects 106.

Conversely, if the total size of the descriptions is less than or equal to the input limit of the LLM(s) and/or the quantity of algorithm tools is less than or equal to the threshold (e.g., 100, 200, 250, etc.), the descriptions corresponding to the algorithm tools may be input into the LLM(s) in a single batch. Based on the input descriptions, the verification and filter layer 108 may determine which algorithm tool(s) need to be performed on each object in the list of objects 106.

In embodiments, the verification and filter layer 108 may establish a mapping relationship between a plurality of editing tasks and a plurality of sets of algorithm tools selected for the plurality of editing tasks. As such, when processing the same task and/or similar tasks in the future, the algorithm tools related to the task can be directly determined based on the mapping relationship to improve the efficiency of the system. Thus, the verification and filter layer 108 may determine, based on the mapping relationship, a set of selected algorithm tools related to any of previously performed editing tasks in response to receiving an editing task that is the same or similar to one of the previously performed editing tasks.

In embodiments, the planning layer 110 receives the object plans. The planning layer 110 determines an order of performing the object plans (e.g., an order of using the selected algorithm tool(s) on an object-by-object basis). The order of performing the object plans may indicate a sequential order in which the objects in the image 101 should be modified. For example, the planning layer 110 may utilize one or more LLMs to analyze the text input 102 and the object plan(s) received from the verification and filter layer 108 to determine the order of performing the object plans. The planning layer 110 may generate a plan 112 (e.g., a global plan). The plan 112 may comprise a plan for implementing the image editing task. The planning layer 110 may generate the plan 112 based on the input text 102 and the determined order of performing the operations. The plan 112 may indicate the order of performing the object plans. For example, the plan 112 associated with the input image 101 may indicate that operations on a first object (e.g., a man) in the input image 101 should be performed first, operations on a second object (e.g., a cat) in the input image 101 should performed second, etc.

In embodiments, the plan 112 can be used to perform a different image editing task at a later time. For example, the plan 112 may be used to perform an image editing task on an image (e.g., the same image or a different image) for the same user or for a different user. At 119a, the system 100 may share the plan 112 with other users (e.g., other users of the system 100), such as within an application and/or a platform associated with the system 100. At 119b, the system 100 may save or store the plan 112 locally (e.g., on the client device used to upload the image 101 and receive the text 102). If the plan 112 is saved or stored locally, the plan 112 may be used by a same or different user to edit an image at a later time on the same client device. At 119c, the system 100 may upload the plan 112 to at least one server computing system. The server computing system may be configured to share the plan 112 with other users for use in image editing tasks. At 119d, the system 100 may export (e.g., send) the plan 112 to another platform or system. The different platform or system may utilize the plan 112 to perform an image editing task and/or to create an image effect.

In embodiments, the scheduling layer 114 may generate executable code based at least in part on the plan 112. The scheduling layer 114 may generate the executable code by determining a complete specification (e.g., detailed information) associated with each algorithm tool (e.g., image editing operation(s)) selected for any particular image editing task. The detailed information associated with a particular selected algorithm tool may indicate how to run that particular selected algorithm tool. For example, the detailed information associated with a particular selected algorithm tool may indicate that the tool is a C++ program or that it is script. The executable code may be generated based on the detailed information associated with each algorithm tool. The scheduling layer 114 may pass the executable code to the execution layer 116. The execution layer 117 may execute the executable code to generate a result 118. The result 118 may comprise an edited version of the image 101. The execution layer 116 may retrieve the selected algorithm tools and execute the executable code to generate a result of performing the particular image editing task.

Unlike the plan 112, which may be saved or stored for later use, the output of the scheduling later 114 may not be saved or stored. The scheduling layer 114 may be platform dependent. A unique (e.g., different) scheduling layer 114 may be used for each image editing platform or system. A unique (e.g., different) scheduling layer 114 may be used for each image editing platform or system because the detailed information associated with each algorithm tool may vary depending on platforms. For example, if the saved plan 112 is used for an image editing task on a first platform, the saved plan 112 may be input into a first version of the scheduling layer 114. The first version of the scheduling layer 114 may be configured to generate executable code corresponding to the plan 112 that is compatible with the first platform. If the saved plan 112 is then used for the image editing task on a second platform, the saved plan 112 may be input into a second version of the scheduling layer 114. The second version of the scheduling layer 114 may be configured to generate executable code corresponding to the plan 112 that is compatible with the second platform. Thus, the same plan 112 may be able to be utilized by various platforms.

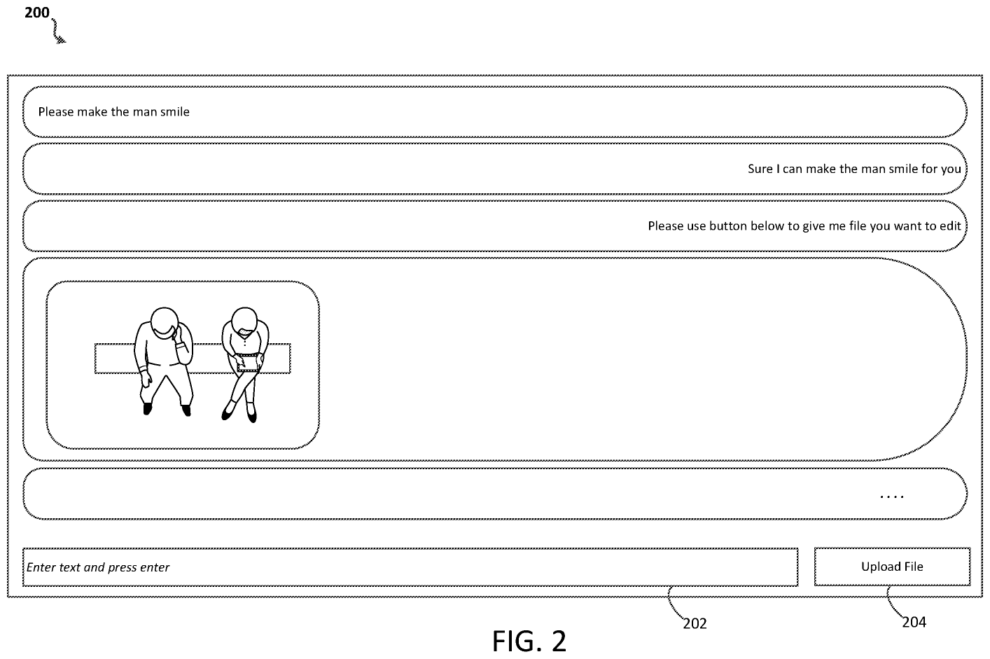

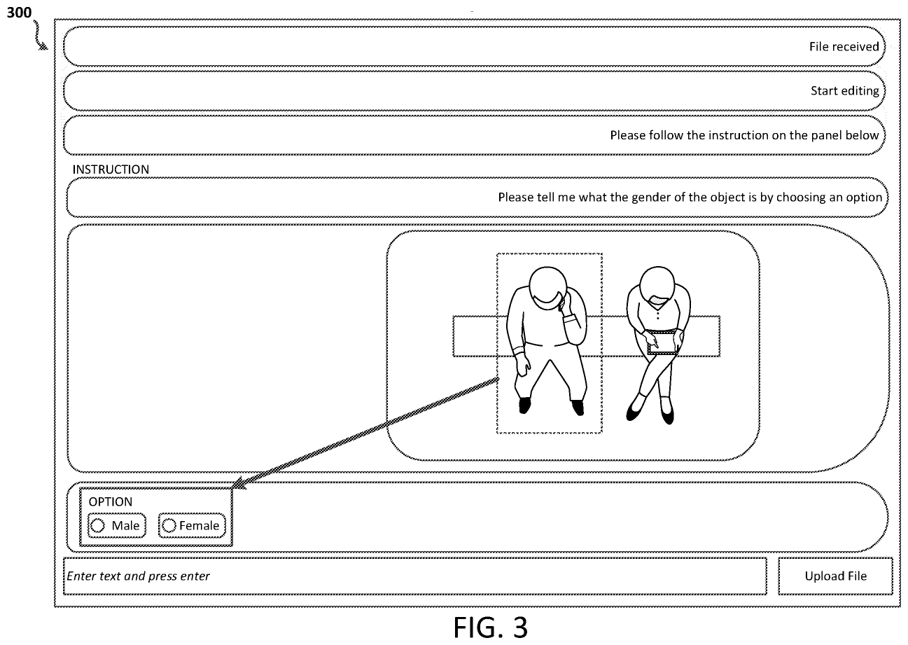

FIGS. 2-4 show example user interfaces (UIs) for implementing dialog-based image editing. As shown in FIGS. 2-3, a user may be able to communicate with an image editing system (e.g., the system 100) in natural language. The user may, in natural language, input text (e.g., text 102) indicating an image editing task that the user wants the image editing system to perform. The text may be input in natural language form. The user may input the text via keyboard, keypad, voice command, etc. The user may input an image (e.g., image 101) which the user wants the image editing system to perform the image editing task on. The image editing system may respond to the user in natural language.

In the example of FIG. 2, the image editing system may receive text indicative of an image editing task, such as “make the man smile.” The text may be input via a text box 202 or received by a voice command. In response to receiving the text, the system may prompt the user, via the interface 200, to upload the image on which the image editing task is to be performed. To prompt the user to upload the image, the image editing system may cause display, via the interface 200, of at least one sentence configured to guide a user to upload the image. In the example of FIG. 2, the following sentence is configured to guide a user to upload the image: “Please use button below to give me file you want to edit.” In response to viewing the sentence(s), the user may upload the image to the system by selecting the button 204.

The system may continue to communicate with the user in natural language in response to the user uploading the image. In the example of FIG. 3, the system may confirm, via the interface 300, that the image has successfully been uploaded. To confirm that the image has successfully been uploaded, the image editing system may cause display, via the interface 300, of at least one sentence configured to confirm upload (e.g., “File received”). In embodiments, the system may determine that additional information is needed to complete the image editing task. In response to determining that additional information is needed to complete the image editing task, the image editing system may prompt the user, via the interface 300, to provide additional information necessary for completing the image editing task. To prompt the user to provide additional information necessary for completing the image editing task, the image editing system may cause display, via the interface 300, of at least one sentence configured to request a user to input the additional information. In the example of FIG. 3, the following sentence is configured to request a user to input the additional information: “Please tell me what the gender of the object is by choosing an option.” In response to the user viewing the sentence(s), the user may provide the additional information (e.g., indicate whether the human in the box is a male or female).

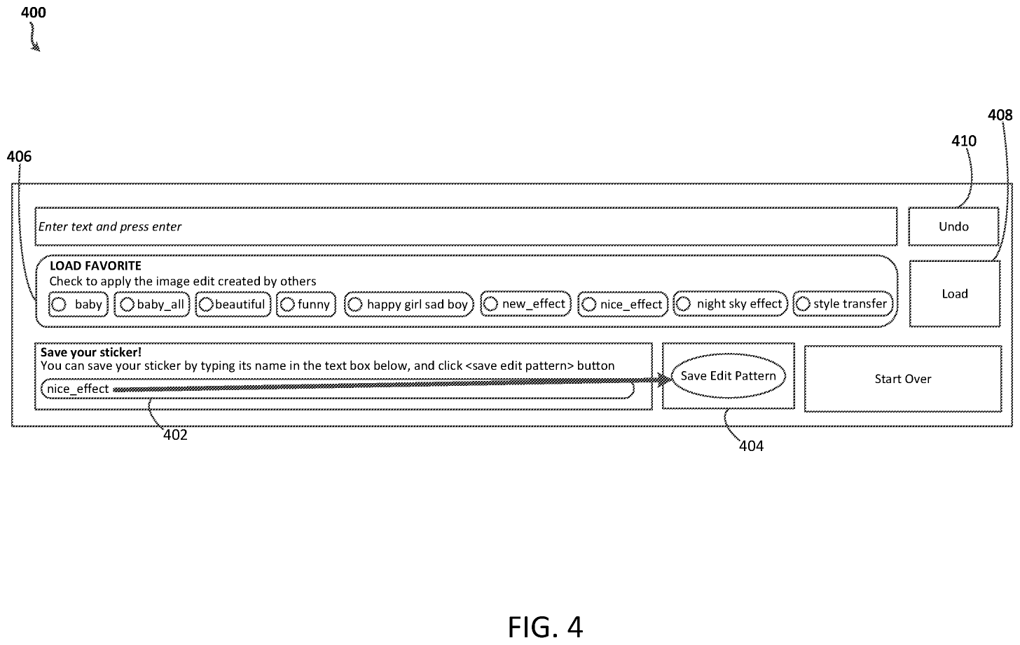

FIG. 4 illustrates an example user interface 400 for implementing dialog-based image editing. In embodiments, after the image editing plan (e.g., plan 112) has been generated (e.g., by the planning layer 110), the image editing plan may be used to perform a same or similar image editing task at a later time. The user may be able to name the image editing plan by entering a plan name in a text box 402. After entering a plan name, the user may save the plan by selecting the box 404. Selecting the box 404 may cause the plan to be saved (e.g., locally and/or on a remote server device), shared with other users, and/or exported to a different system or platform. The saved, shared, uploaded, and/or exported plan may then be used to perform a same or similar image editing task at a later time.

In embodiments, a user may be able to utilize an image editing plan created by a different user. To utilize an image editing plan created by a different user, the user may select, in the box 406, an image editing plan from a plurality of previously created image editing plans. The plurality of previously created image editing plans may have been uploaded, shared, and/or saved to the system 100. After selecting an image editing plan from a plurality of previously created image editing plans, the user may select the button 408. Selection of the button 408 may cause the selected image editing plan to be applied to an image uploaded by the user. For example, selection of the button 408 may cause the selected image editing plan to be input into a scheduling layer on a client computing device associated with the user. The scheduling layer may generate executable code based on the selected image editing plan. The executable code may be executed to generate an edited image.

In embodiments, the user may select a button 410. Selection of the button 410 may cause the undoing (e.g., reversal) of one or more image editing operations that have been performed on the image uploaded by the user. For example, the user may select the button 410 to undo the application of the selected image editing plan on the image. As another example, the user may select the button 410 to undo the application of one or more image editing operations that have been performed on the image in response to natural language input by the user.

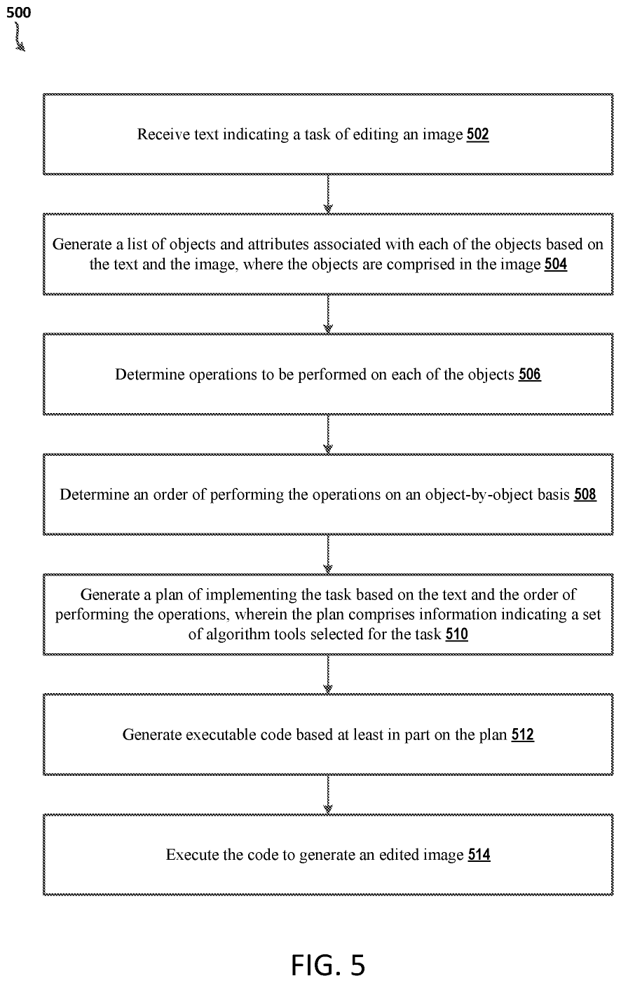

FIG. 5 illustrates an example process 500 for implementing dialog-based image editing. Although depicted as a sequence of operations in FIG. 5, those of ordinary skill in the art will appreciate that various embodiments may add, remove, reorder, or modify the depicted operations.

At 502, text may be received. The text may indicate a task of editing an image. The image may comprise any image that needs editing or modifications. In some examples, the image may comprise an image that is uploaded by a user. In other examples, the image may comprise an image generated based on a user input. The text may comprise natural language, such as natural language that describes the image editing task that the user wants the image editing system to perform on the image.

At 504, a list of objects and attributes associated with each of the objects may be generated. The list of objects and attributes may be generated based on the text and the image. The objects may be comprised in the image. The list of objects and attributes may comprise a list of objects depicted in the image, such as people, animals, inanimate objects, etc. For example, the list of objects and attributes may indicate how many objects are in the image, and a type and position associated with each image. The list of objects and their respective attributes may comprise attributes corresponding to each object. If an object is a person, the corresponding attributes may indicate gender, facial expression, hair color, etc. If an object is a cat, the corresponding attributes may indicate color, size, etc. The list of objects and attributes may contain a greater amount of information about the image and may be more accurate than the brief text description that is typically generated by existing techniques. The list of objects and attributes may be generated using one or more visual algorithms. The visual algorithm(s) may be selected from a plurality of visual algorithms. Each of the plurality of visual algorithms may be used to perform a specific task, e.g., detection of face(s). The visual algorithm(s) may be selected (e.g., by an LLM) based on the image and/or the text.

At 506, operations to be performed on each of the objects may be determined. To determine the operations (e.g., algorithm tools) to be performed on each of the objects in the list of objects, it may be determined, for each object in the list of objects, whether one or more image editing operations need to be performed on the object. Determining whether one or more image editing operations need to be performed on the object may be based on the text. For example, if the text indicates that the user wants to change the facial expression of a man (but not a woman) in the image, it may be determined that one or more operations need to be performed on the man and that no operations need to be performed on the woman. If it is determined that one or more operations need to be performed on a particular object in the list of objects, it may be determined which specific operations need to be applied on that object. For example, one or more LLMs may be utilized to analyze the image editing task indicated by the text to determine which operation(s), if any, need to be performed on each object. The operations(s) to be performed on a particular object in the list of objects may herein be referred to as an “object plan” for the object.

At 508, an order of performing the operations may be determined. The order of performing the operations may be determined on an object-by-object basis. For example, an order of performing the object plans may be determined. The order of performing the object plans may indicate a sequential order in which the objects in the image should be modified. One or more LLMs may be utilized to analyze the text and the object plan(s) to determine the order of performing the object plans.

At 510, a plan of implementing the task may be generated. The plan may be generated based on the text and the order of performing the operations. The plan may comprise information indicating a set of algorithm tools selected for the image editing task. The plan may indicate the order of performing the object plans. At 512, executable code may be generated. The executable code may be generated based at least in part on the plan. The executable code may be generated by determining detailed information associated with each selected algorithm tool (e.g., image editing operation(s)). The detailed information associated with a particular selected algorithm tool may indicate how to run that particular selected algorithm tool. For example, the detailed information associated with a particular selected algorithm tool may indicate that the tool is a C++ program or that it is script. The executable code may be generated based on the detailed information associated with each algorithm tool. The executable code may be passed to an execution layer. At 514, the code may be executed. The code may be executed (e.g., by the execution layer) to generate an edited image.

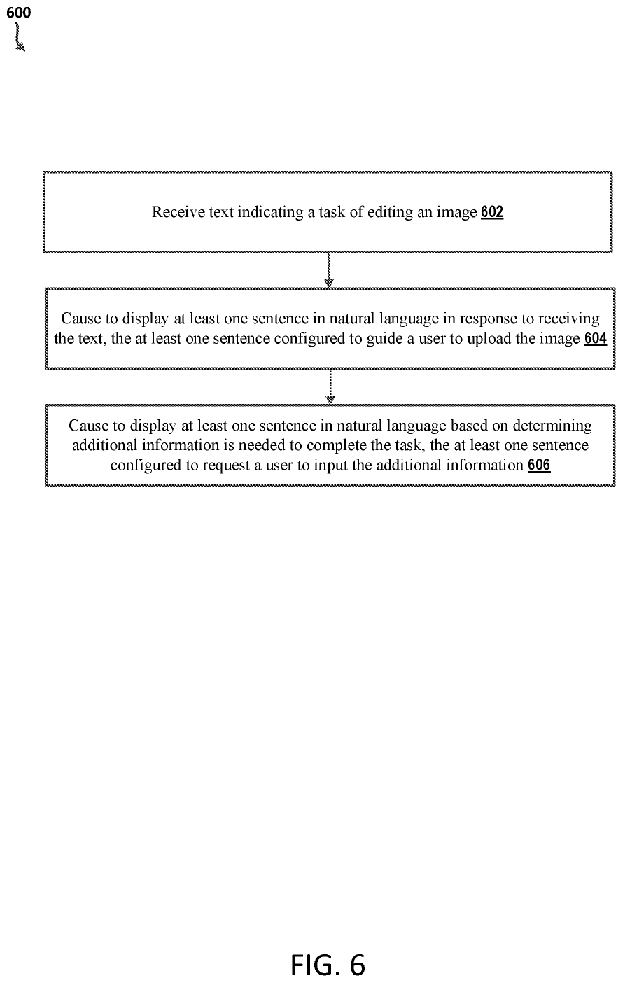

FIG. 6 illustrates an example process 600 for implementing dialog-based image editing. Although depicted as a sequence of operations in FIG. 6, those of ordinary skill in the art will appreciate that various embodiments may add, remove, reorder, or modify the depicted operations.

At 602, text may be received. The text may indicate a task of editing an image. The image may comprise an image that a user wants to edit or modify. At 604, display of at least one sentence may be caused. The display of the sentence(s) may be caused in natural language. The display of the sentence(s) may be caused in response to receiving the text. The sentence(s) may be configured to guide a user to upload the image. The user may upload the image accordingly. At 606, display of at least one sentence may be caused. The sentence(s) may be displayed in natural language. Display of the sentence(s) may be caused based on determining that additional information is needed to complete the image editing task. The at least one sentence may be configured to request a user to input the additional information.

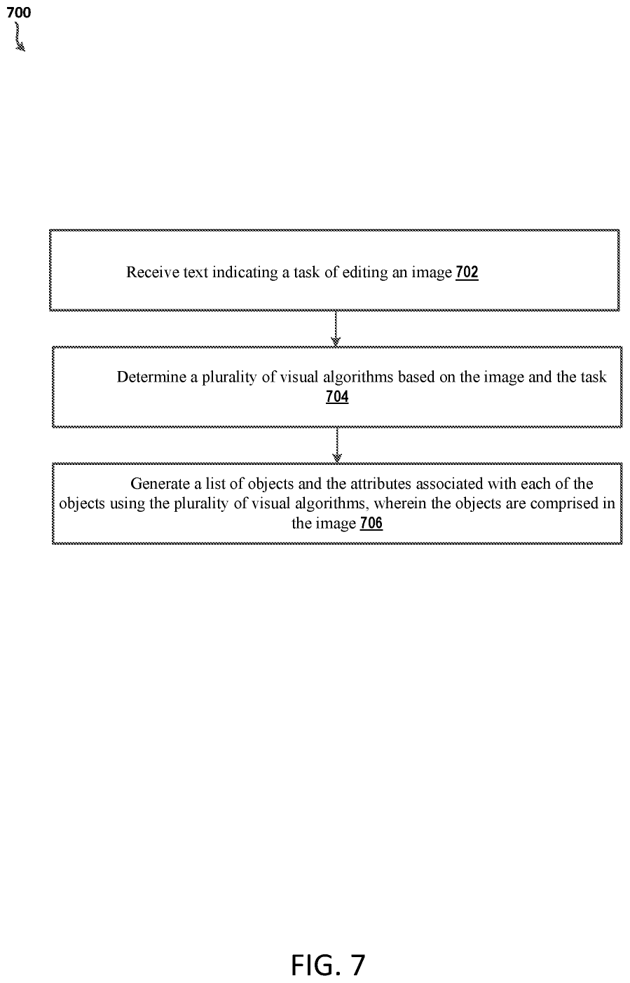

FIG. 7 illustrates an example process 700 for implementing dialog-based image editing. Although depicted as a sequence of operations in FIG. 7, those of ordinary skill in the art will appreciate that various embodiments may add, remove, reorder, or modify the depicted operations.

At 702, text may be received. The text may indicate a task of editing the image. The image may comprise an image that a user wants to edit or modify. The image may comprise an image generated by a machine learning model based on user input. The user may upload the image to an image editing system. The text may comprise natural language, such as natural language that describes the image editing task that the user wants the image editing system to perform on the image.

At 704, a plurality of visual algorithms may be determined. The plurality of visual algorithms may be determined based on the image and the task. Each of the plurality of visual algorithms may be used to perform a specific task. For example, one of the plurality of visual algorithms may be configured to perform a face detection task. As another example, one of the plurality of visual algorithms may be configured to perform human body detection. As another example, one of the plurality of visual algorithms may be an image style algorithm. One or more large LLMs may be utilized to analyze the image editing task and determine which visual algorithm(s) should be used to perform the image editing task.

A list of objects and their respective attributes may be generated using the selected plurality of visual algorithm(s). At 706, a list of objects and the attributes associated with each of the objects may be generated. The list of objects and the attributes may be generated using the plurality of visual algorithms. The objects are comprised in the image. The list of objects may comprise a list of objects depicted in the input image, such as people, animals, inanimate objects, etc. For example, the list of objects and attributes may indicate how many objects are in the image, and a type and position associated with each image. The attributes may comprise attributes corresponding to each object. If an object is a person, the corresponding attributes may indicate gender, facial expression, hair color, etc. If an object is a cat, the corresponding attributes may indicate color, size, etc. The list of objects and attributes may contain a greater amount of information about the input image and may be more accurate than the brief text description that is typically generated by existing techniques.

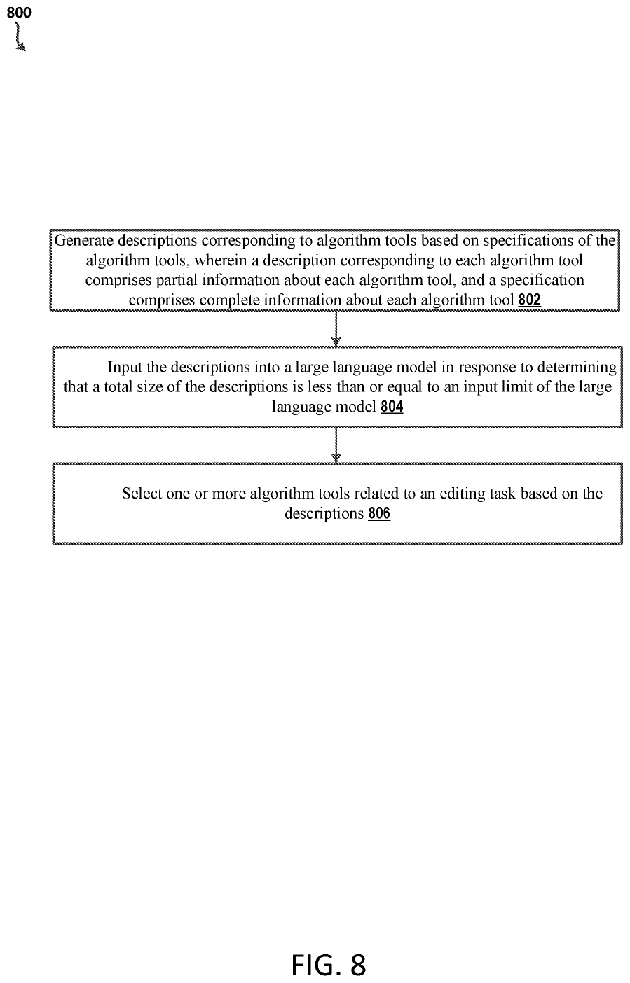

FIG. 8 illustrates an example process 800 for implementing dialog-based image editing. Although depicted as a sequence of operations in FIG. 8, those of ordinary skill in the art will appreciate that various embodiments may add, remove, reorder, or modify the depicted operations.

At 802, descriptions may be generated. The descriptions may correspond to algorithm tools. The descriptions may be generated based on specifications of the algorithm tools. A description corresponding to each algorithm tool may comprise partial information about each algorithm tool. A specification may comprise complete information about each algorithm tool. The descriptions may be input into one or more LLM(s). At 804, the descriptions may be input into a large language model. The descriptions may be input into a large language model in response to determining that a total size of the descriptions is less than or equal to an input limit of the large language model. Based on the input descriptions, one or more algorithm tools may be determined. At 806, one or more algorithm tools may be selected. The one or more algorithms may relate to an image editing task. The one or more algorithms may be selected based on the input descriptions. The LLM(s) may utilize the descriptions associated with the each of the plurality of algorithm tools, along with input text indicated the image editing task, to determine which algorithm tools need to be performed on each object in the image.

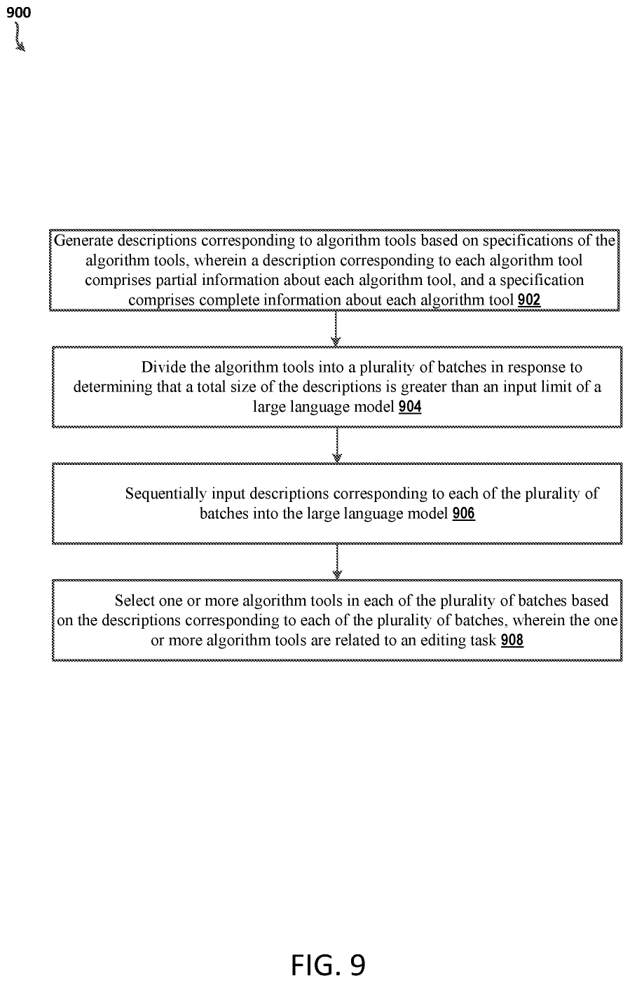

FIG. 9 illustrates an example process 900 for implementing dialog-based image editing. Although depicted as a sequence of operations in FIG. 9, those of ordinary skill in the art will appreciate that various embodiments may add, remove, reorder, or modify the depicted operations.

At 902, descriptions may be generated. The descriptions may correspond to algorithm tools. The descriptions may be generated based on specifications of the algorithm tools. A description corresponding to each algorithm tool may comprise partial information about each algorithm tool. A specification may comprise complete information about each algorithm tool.

At 904, the algorithm tools may be divided into a plurality of batches. The algorithm tools may be divided into the plurality of batches in response to determining that a total size of the descriptions is greater than an input limit of a large language model. The size of the descriptions in each of the batches may be less than or equal to the input limit of the large language model. At 906, the descriptions corresponding to each of the plurality of batches may be sequentially input into the large language model. For example, descriptions corresponding to the algorithm tools in a first batch of the plurality of batches may be input into the LLM(s), then descriptions corresponding to the algorithm tools in a second batch of the plurality of batches may be input into the LLM(s), and so on. Based on the input descriptions, one or more algorithm tools may be determined. At 806, one or more algorithm tools in each of the plurality of batches may be selected. The one or more algorithms may relate to an editing task. The one or more algorithms may be selected based on the input descriptions. The LLM(s) may utilize the descriptions associated with the each of the plurality of algorithm tools, along with input text indicated the editing task, to determine which algorithm tools need to be performed on each object in the image.

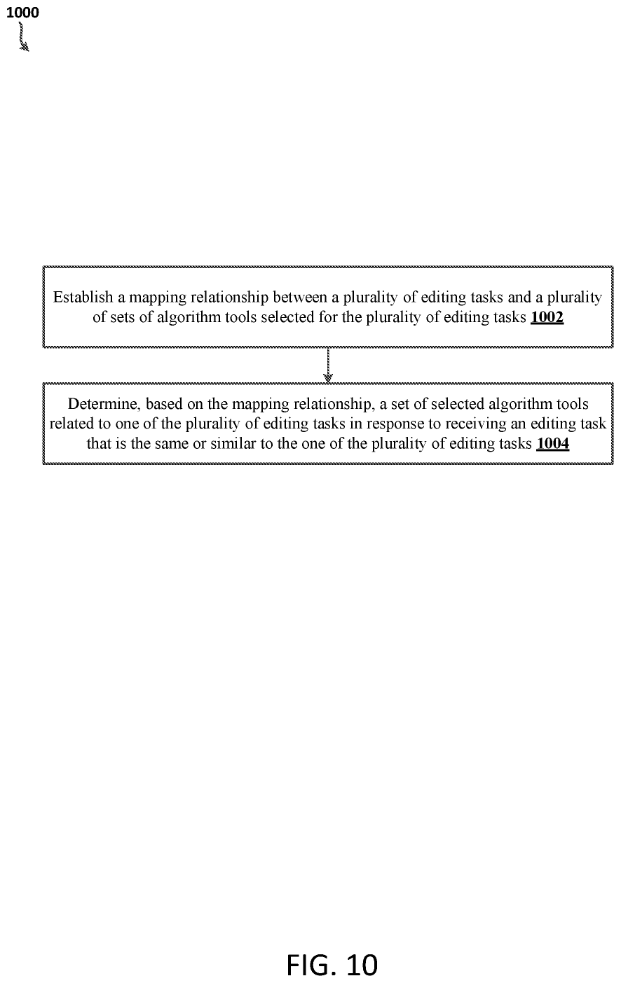

FIG. 10 illustrates an example process 1000 for implementing dialog-based image editing. Although depicted as a sequence of operations in FIG. 10, those of ordinary skill in the art will appreciate that various embodiments may add, remove, reorder, or modify the depicted operations.

At 1002, a mapping relationship may be established. The mapping relationship may be established between a plurality of editing tasks and a plurality of sets of algorithm tools. The plurality of sets of algorithm tools may be selected for the plurality of editing tasks. For example, a first set of algorithm tools from the plurality of sets of algorithm tools may be selected by the system for a first editing task from the plurality of editing tasks. A second set of algorithm tools from the plurality of sets of algorithm tools may be selected by the system for a second editing task from the plurality of editing tasks, and so on. The mapping relationship may be established between the first set of algorithm tools and the first editing task, the second set of algorithm tools and the second editing task, and so on.

A user may upload a new image and input a new editing task. The new editing task may be the same or similar to one of the plurality of editing tasks that are previously performed. At 1004, a set of selected algorithm tools may be determined based on the mapping relationship. The set of selected algorithm tools may be directly determined for the new editing task based on the mapping relationship. The set of selected algorithm tools may be related to the one of the plurality of editing tasks that is the same or similar to the new editing task. The set of previously selected algorithm tools may be directly determined in response to receiving the new editing task. Thus, the efficiency of performing the new editing task is improved.

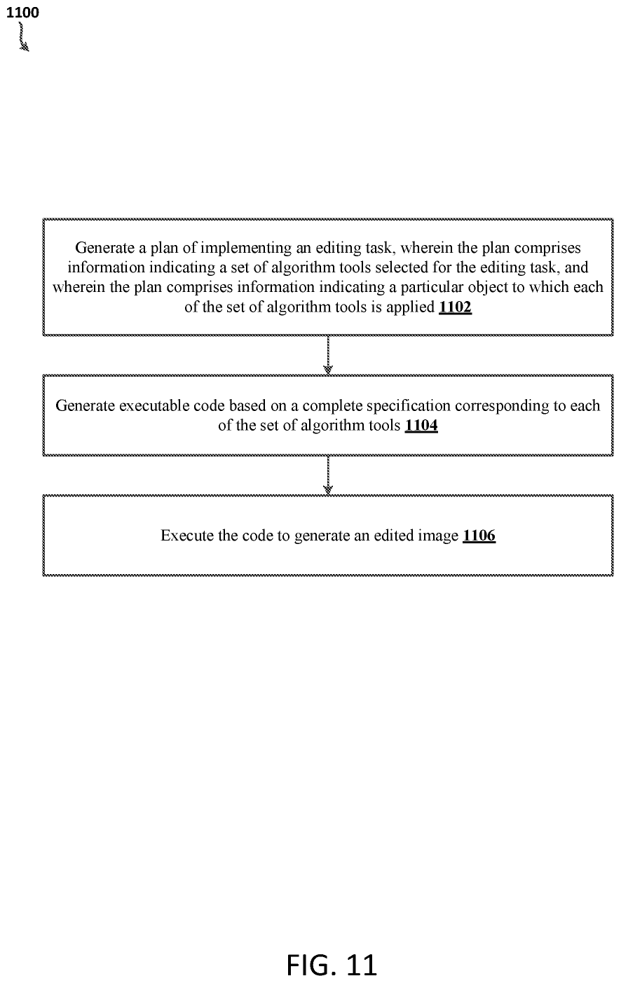

FIG. 11 illustrates an example process 1100 for implementing dialog-based image editing. Although depicted as a sequence of operations in FIG. 11, those of ordinary skill in the art will appreciate that various embodiments may add, remove, reorder, or modify the depicted operations.

At 1102, a plan may be generated. The plan may be a plan for implementing an image editing task. The plan may comprise information indicating a set of algorithm tools selected for the image editing task. The plan may comprise information indicating a particular object to which each of the set of algorithm tools is applied. The plan may indicate an order of performing operations on the objects in an image using the set of algorithm tools. At 1104, executable code may be generated. The executable code may be generated based on complete specifications (e.g., complete information) corresponding to the set of algorithm tools. Detailed information associated with each algorithm tool may be determined based on a corresponding complete specification. The detailed information associated with a particular selected algorithm tool may indicate how to run that particular algorithm tool. For example, the detailed information associated with a particular selected algorithm tool may indicate that the tool is a C++ program or that it is script. The executable code may generated based on the detailed information associated with each algorithm tool. At 1106, the code may be executed. The executable code may be executed to generate an edited image.

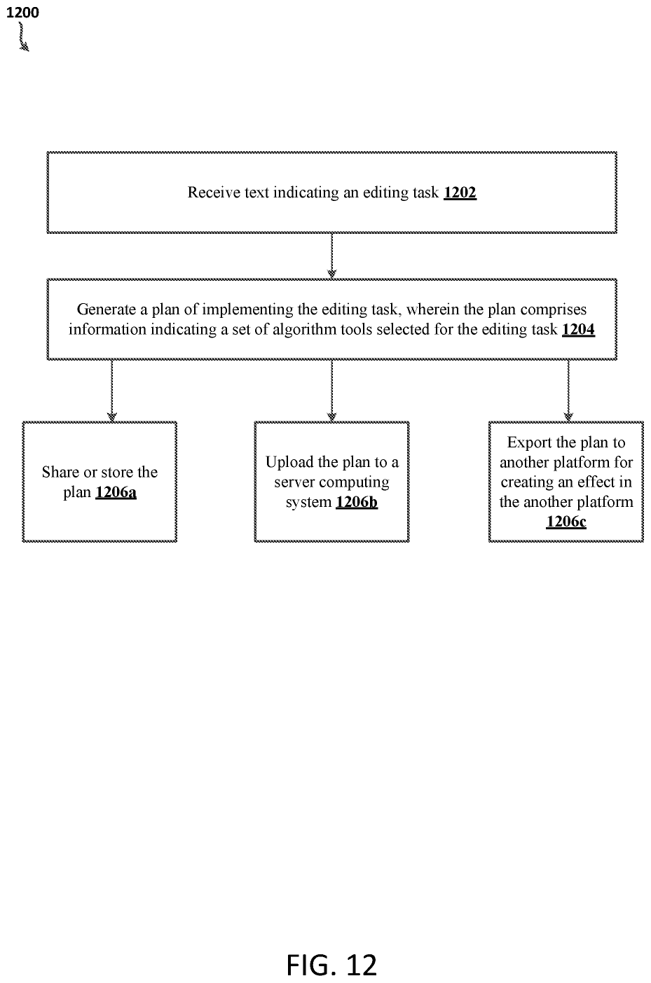

FIG. 12 illustrates an example process 1200 for implementing dialog-based image editing. Although depicted as a sequence of operations in FIG. 12, those of ordinary skill in the art will appreciate that various embodiments may add, remove, reorder, or modify the depicted operations.

At 1202, text may be received. The text may indicate a task of editing an image. The image may comprise an image that a user wants to edit or modify. The user may upload the image to an image editing system. The text may comprise natural language, such as natural language that describes the image editing task that the user wants the image editing system to perform on the image. At 1204, a plan may be generated. The plan may be a plan for implementing the image editing task. The plan may comprise information indicating a set of algorithm tools selected for the image editing task. The plan may comprise information indicating a particular object to which each of a set of algorithm tools selected for the image editing task is applied. The plan may indicate an order of performing operations on the objects using the set of algorithm tools.

The plan can be used to perform a same or similar image editing task at a later time. For example, the plan may be used to perform an image editing task on an image (e.g., the same image or a different image) for the same user or for a different user. At 1206a, the plan may be shared and/or stored. For example, the plan may be stored locally. At 1206b, the plan may be uploaded to a server computing system. The server computing system may be configured to share the plan with other users for use in image editing tasks. At 1206c, the plan may be exported. The plan may be exported to another platform for creating an effect in the another (e.g., different) platform. The different platform or system may utilize the plan to perform an image editing task and/or to create an image effect.

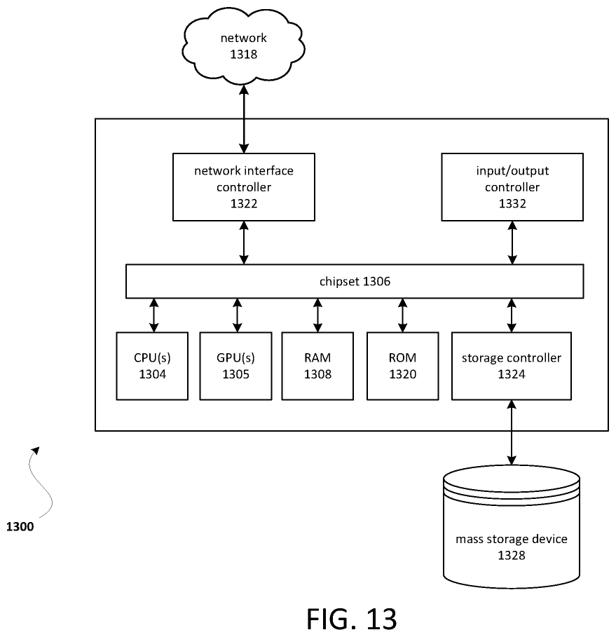

FIG. 13 illustrates a computing device that may be used in various aspects, such as the services, networks, modules, and/or devices depicted in FIG. 1. With regard to the example architecture of FIG. 1, the cloud network (and any of its components), the client devices, and/or the network may each be implemented by one or more instance of a computing device 1300 of FIG. 13. The computer architecture shown in FIG. 13 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1300 may include a baseboard, or “motherboard,” which is a printed circuit board to which a multitude of components or devices may be connected by way of a system bus or other electrical communication paths. One or more central processing units (CPUs) 1304 may operate in conjunction with a chipset 1306. The CPU(s) 1304 may be standard programmable processors that perform arithmetic and logical operations necessary for the operation of the computing device 1300.

The CPU(s) 1304 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1304 may be augmented with or replaced by other processing units, such as GPU(s) 1305. The GPU(s) 1305 may comprise processing units specialized for but not necessarily limited to highly parallel computations, such as graphics and other visualization-related processing.

A chipset 1306 may provide an interface between the CPU(s) 1304 and the remainder of the components and devices on the baseboard. The chipset 1306 may provide an interface to a random-access memory (RAM) 1308 used as the main memory in the computing device 1300. The chipset 1306 may further provide an interface to a computer-readable storage medium, such as a read-only memory (ROM) 1320 or non-volatile RAM (NVRAM) (not shown), for storing basic routines that may help to start up the computing device 1300 and to transfer information between the various components and devices. ROM 1320 or NVRAM may also store other software components necessary for the operation of the computing device 1300 in accordance with the aspects described herein.

The computing device 1300 may operate in a networked environment using logical connections to remote computing nodes and computer systems through local area network (LAN). The chipset 1306 may include functionality for providing network connectivity through a network interface controller (NIC) 1322, such as a gigabit Ethernet adapter. A NIC 1322 may be capable of connecting the computing device 1300 to other computing nodes over a network 1316. It should be appreciated that multiple NICs 1322 may be present in the computing device 1300, connecting the computing device to other types of networks and remote computer systems.

The computing device 1300 may be connected to a mass storage device 1328 that provides non-volatile storage for the computer. The mass storage device 1328 may store system programs, application programs, other program modules, and data, which have been described in greater detail herein. The mass storage device 1328 may be connected to the computing device 1300 through a storage controller 1324 connected to the chipset 1306. The mass storage device 1328 may consist of one or more physical storage units. The mass storage device 1328 may comprise a management component 1313. A storage controller 1324 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1300 may store data on the mass storage device 1328 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1328 is characterized as primary or secondary storage and the like.

For example, the computing device 1300 may store information to the mass storage device 1328 by issuing instructions through a storage controller 1324 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1300 may further read information from the mass storage device 1328 by detecting the physical states or characteristics of one or more particular locations within the physical storage units.

In addition to the mass storage device 1328 described above, the computing device 1300 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1300.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1328 depicted in FIG. 13, may store an operating system utilized to control the operation of the computing device 1300. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1328 may store other system or application programs and data utilized by the computing device 1300.

The mass storage device 1328 or other computer-readable storage media may also be encoded with computer-executable instructions, which, when loaded into the computing device 1300, transforms the computing device from a general-purpose computing system into a special-purpose computer capable of implementing the aspects described herein. These computer-executable instructions transform the computing device 1300 by specifying how the CPU(s) 1304 transition between states, as described above. The computing device 1300 may have access to computer-readable storage media storing computer-executable instructions, which, when executed by the computing device 1300, may perform the methods described herein.

A computing device, such as the computing device 1300 depicted in FIG. 13, may also include an input/output controller 1332 for receiving and processing input from a number of input devices, such as a keyboard, a mouse, a touchpad, a touch screen, an electronic stylus, or other type of input device. Similarly, an input/output controller 1332 may provide output to a display, such as a computer monitor, a flat-panel display, a digital projector, a printer, a plotter, or other type of output device. It will be appreciated that the computing device 1300 may not include all of the components shown in FIG. 13, may include other components that are not explicitly shown in FIG. 13, or may utilize an architecture completely different than that shown in FIG. 13.

As described herein, a computing device may be a physical computing device, such as the computing device 1300 of FIG. 13. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of implementing dialog-based image editing, comprising:
receiving text indicating a task of editing an image generating a list of objects and attributes associated with each of the objects based on the text and the image, wherein the objects are comprised in the image;
determining operations to be performed on each of the objects;
determining an order of performing the operations on an object-by-object basis;
generating a plan of implementing the task based on the text and the order of performing the operations, wherein the plan comprises information indicating a set of algorithm tools selected for the task; and
generating an edited image based at least in part on the plan.

2. The method of claim 1, further comprising:
causing to display at least one sentence in natural language in response to receiving the text, the at least one sentence configured to guide a user to upload the image.

3. The method of claim 1, further comprising:
causing to display at least one sentence in natural language based on determining additional information is needed to complete the task, the at least one sentence configured to request a user to input the additional information.

4. The method of claim 1, further comprising:
determining a plurality of visual algorithms based on the image and the task; and
generating the list of objects and the attributes associated with each of the objects using the plurality of visual algorithms.

5. The method of claim 1, further comprising:
generating descriptions corresponding to algorithm tools based on specifications of the algorithm tools, wherein a description corresponding to each algorithm tool comprises partial information about each algorithm tool, and a specification comprises complete information about each algorithm tool.

6. The method of claim 5, further comprising:
inputting the descriptions into a large language model in response to determining that a total size of the descriptions is less than or equal to an input limit of the large language model; and
selecting one or more algorithm tools related to the task of editing the image based on the descriptions.

7. The method of claim 5, further comprising:
dividing the algorithm tools into a plurality of batches in response to determining that a total size of the descriptions is greater than an input limit of a large language model;
sequentially inputting descriptions corresponding to each of the plurality of batches into the large language model; and
selecting one or more algorithm tools in each of the plurality of batches based on the descriptions corresponding to each of the plurality of batches, wherein the one or more algorithm tools are related to the task of editing the image.

8. The method of claim 1, further comprising:
establishing a mapping relationship between a plurality of editing tasks and a plurality of sets of algorithm tools selected for the plurality of editing tasks; and
determining, based on the mapping relationship, a set of selected algorithm tools related to one of the plurality of editing tasks in response to receiving an editing task that is the same or similar to the one of the plurality of editing tasks.

9. The method of claim 1, further comprising:
generating information indicating a particular object in the list to which each of the set of algorithm tools is applied.

10. The method of claim 1, further comprising:
generating executable code based at least in part on the plan, wherein the generating executable code based at least in part on the plan further comprise generating the executable code based on a complete specification corresponding to each of the set of algorithm tools; and
executing the code to generate the edited image.

11. The method of claim 1, further comprising:
sharing or storing the plan;
uploading the plan to a server computing system; or
exporting the plan to another platform for creating an effect in the another platform.

12. A system, comprising:
at least one processor; and
at least one memory comprising computer-readable instructions that upon execution by the at least one processor cause the system to perform operations comprising:
receiving text indicating a task of editing an image;
generating a list of objects and attributes associated with each of the objects based on the text and the image, wherein the objects are comprised in the image;
determining operations to be performed on each of the objects;
determining an order of performing the operations on an object-by-object basis;
generating a plan of implementing the task based on the text and the order of performing the operations, wherein the plan comprises information indicating a set of algorithm tools selected for the task; and
generating an edited image based at least in part on the plan.

13. The system of claim 12, the operations further comprising:
displaying at least one sentence in natural language based on determining additional information is needed to complete the task, the at least one sentence configured to request a user to input the additional information.

14. The system of claim 12, the operations further comprising:
determining a plurality of visual algorithms based on the image and the task; and
generating the list of objects and the attributes associated with each of the objects using the plurality of visual algorithms.

15. The system of claim 12, the operations further comprising:
generating descriptions corresponding to algorithm tools based on specifications of the algorithm tools, wherein a description corresponding to each algorithm tool comprises partial information about each algorithm tool, and a specification comprises complete information about each algorithm tool;
inputting the descriptions into a large language model in response to determining that a total size of the descriptions is less than or equal to an input limit of the large language model; and
selecting one or more algorithm tools related to the task of editing the image based on the descriptions.

16. The system of claim 12, the operations further comprising:
generating descriptions corresponding to algorithm tools based on specifications of the algorithm tools, wherein a description corresponding to each algorithm tool comprises partial information about each algorithm tool, and a specification comprises complete information about each algorithm tool;
dividing the algorithm tools into a plurality of batches in response to determining that a total size of the descriptions is greater than an input limit of a large language model;
sequentially inputting descriptions corresponding to each of the plurality of batches into the large language model; and
selecting one or more algorithm tools in each of the plurality of batches based on the descriptions corresponding to each of the plurality of batches, wherein the one or more algorithm tools are related to the task of editing the image.

17. A non-transitory computer-readable storage medium, storing computer-readable instructions that upon execution by a processor cause the processor to implement operations, the operation comprising:
receiving text indicating a task of editing an image;
generating a list of objects and attributes associated with each of the objects based on the text and the image, wherein the objects are comprised in the image;
determining operations to be performed on each of the objects;
determining an order of performing the operations on an object-by-object basis;
generating a plan of implementing the task based on the text and the order of performing the operations, wherein the plan comprises information indicating a set of algorithm tools selected for the task; and
generating an edited image based at least in part on the plan.

18. The non-transitory computer-readable storage medium of claim 17, the operations further comprising:
displaying at least one sentence in natural language based on determining additional information is needed to complete the task, the at least one sentence configured to request a user to input the additional information.

19. The non-transitory computer-readable storage medium of claim 17, the operations further comprising:
determining a plurality of visual algorithms based on the image and the task; and
generating the list of objects and the attributes associated with each of the objects using the plurality of visual algorithms.

20. The non-transitory computer-readable storage medium of claim 17, the operations further comprising:
generating descriptions corresponding to algorithm tools based on specifications of the algorithm tools, wherein a description corresponding to each algorithm tool comprises partial information about each algorithm tool, and a specification comprises complete information about each algorithm tool;
inputting the descriptions into a large language model in response to determining that a total size of the descriptions is less than or equal to an input limit of the large language model; and
selecting one or more algorithm tools related to the task of editing the image based on the descriptions.
